(19) United States
(12) Patent Application Publication
(10) Pub. No.: US 2008/0235597 A1
(43) Pub. Date: Sep. 25, 2008

(54) SYSTEMS AND METHODS OF DATA INTEGRATION FOR CREATING CUSTOM BOOKS

(76) Inventors: Mor Schlesinger, Ramat Hsharon (IL); Joseph Hartal, Tel-Aviv (IL); Rami Abramson, Jaffa (IL)

Correspondence Address: KNOBBE MARTENS OLSON & BEAR LLP, 2040 MAIN STREET, FOURTEENTH FLOOR, IRVINE, CA, 92614, US

(21) Appl. No.: 12/050,859

(22) Filed: Mar. 18, 2008

Related U.S. Application Data
(60) Provisional application No. 60/895,661, filed on Mar. 19, 2007.

(51) Int. Cl. G06F 3/00

(52) U.S. Cl. 715/744

(57) ABSTRACT

Systems and methods for creating customized or individualized documents, including but not limited to printed documents such as bound books. An open application program interface (API) facilitates data integration and aggregation between a document creation system and one or more content provider partners. A customer can select a customized document, preview the document, and modify the document as desired, for example, by adding text, comments, photos, and the like.

### CROSS-REFERENCE TO RELATED APPLICATIONS

This application claims the benefit of U.S. provisional application 60/895,661 filed Mar. 19, 2007 entitled “APPLICATION PROGRAM INTERFACE FOR CREATING CUSTOM ANNOTATED BOOKS” and which is incorporated herein in its entirety by reference.

### BACKGROUND OF THE INVENTION

1. Field of the Invention

The invention relates to the field of customized book or other document creation and printing and to systems and methods to allow data integration across multiple clients.

2. Description of the Related Art

There is a widespread desire for a variety of remembrance or encyclopedic materials to provide people with mementos of people, events, and/or eras with which they have a connection. People also desire reference materials for topics of interest. Printed materials, such as books, pamphlets, magazines, and the like are a popular memento or reference format. For example, students may purchase yearbooks or annuals with pictures of their classmates and events during the school year, articles or text summarizing events throughout the year, humorous quotes or articles, and the like.

People may also have interest in an encyclopedic book providing information and photos of conflicts or other world events. For example, a veteran of the Gulf War may be interested in purchasing a book containing accounts of battles in the war, photos from the combat zone, identification of serving units, and the like. A person may also be interested in a travel book directed to a specific area, such as the Greek Islands where they recently vacationed, to provide a remembrance or memento of their enjoyable vacation trip.

Such remembrance documents or books have been generally compiled by a publisher who either obtains the photographs and text themselves, receives photographs and text from a group of potential purchasers of the remembrance, for example in the case of year books or annuals, or uses a combination of obtained and submitted content. However, the conventional process of compiling content and printing and binding the material into a remembrance book generally requires that the same content be printed multiple times for purchase by those interested in the book.

However, a given individual may have personal photos, comments, notes, and the like that they would wish to have included in a durable, printed record with content provided by others. While a customer can purchase a remembrance document of general interest, it has not been feasible to provide a customized remembrance document that includes material of general interest, for example, scenery photos and description of a country with content of specific individual interest, for example, personal photos and travel itinerary of their visit to that country. A high quality printed document combining an individual's unique desired combination of personally provided/created content with relevant content from others, such as publically available content and/or content from a third party partner would be highly desired.

### SUMMARY OF THE INVENTION

Aspects of the invention are based at least in part on an appreciation that there is an unsatisfied need for systems and methods to allow a user to create a durable high quality remembrance/reference document or storage media in a rapid, convenient, and inexpensive manner that allows them to customize the remembrance to their individual interests/experiences. Some embodiments include a computer implemented system that utilizes an open application program interface (API) to allow a printed document creation system to easily interface with one or more partner content providers and one or more users/customers to allow the customer to indicate their interests, provide their own individual content as desired, and obtain content from the content partners to compile/aggregate an individually customized remembrance document. In some embodiments, the printed document creator system can use the compiled/aggregated data to prepare a printed and bound remembrance book that can be delivered to or picked up by the customer. In some embodiments, a customer can preview the aggregated content prior to printing and binding of a remembrance book.

Some embodiments support collaboration or sharing among multiple users. For example, a first user can create a book making site and personalize a document for their individual interests and desires. A second user can be offered the opportunity to view the first user's custom document, purchase the first user's custom document, modify the first user's custom document, and/or save a modified version of the first user's custom document either as a new document or as revised version of the first user's custom document.

In some embodiments, content partners can establish periodic communication with a document creator system to periodically update or provide content to the document creator system in a manner that can be synchronous or asynchronous with respect to specific indications of customer interest in a remembrance document. In some embodiments, a process of compiling/aggregating content can be initiated before a customer has completely specified their interest in the remembrance document. For example, in one embodiment, upon a customer indicating interest in a remembrance document, a document creation system can begin aggregation or compilation of a prepared template of content while awaiting further instructions and/or individualized content from the customer. These aspects improve the real-time performance of the system and provide increased convenience and customer satisfaction by more rapidly preparing and presenting the desired remembrance document.

Some embodiments provide increased marketing and branding opportunities for content providers by providing an additional avenue for distribution and purchasing/licensing of their content. For example, in some embodiments, a journalistic content provider can partner with a book creation system to provide photographs, historical accounts, editorials, and other content to be included with prepared remembrance documents. In some embodiments, content partners can designate at least some data, such as branding data for example, as non-selectable. Thus, in some embodiments, a content provider can be assured that at least certain of their provided data will appear in the final product. An open API aspect of at least certain embodiments facilitates communication between content partners and a document creation system to offer greater market opportunities for the content provider partners and a wider scope of content availability to the document creation system to provide greater opportunities and variations of content to their customers.

One embodiment includes a system for creating customized documents, the system comprising a document creation system adapted to create customized documents, a user interface adapted to allow a first user to input data and commands, a communication network configured to communicate with one or more content partners and with the user interface to receive content data and to exchange requests, and a document creation application, wherein the application is configured to allow the user to indicate interest in creating a first customized document and communicate that interest to the document creation system via the user interface and to induce the document creation system to obtain content data from the one or more content partners corresponding to the user's indicated interest and to create the first document customized according to the user's indicated interest.

Another embodiment includes a method of creating a customized document, the method comprising receiving from a user an indication of interest in creating a customized document, aggregating data from one or more content providers according to the user's indicated interests, creating the customized document, receiving an indication of desire to purchase the customized document, and providing a durable record of the customized document.

A further embodiment includes computer readable storage media provided with instructions to induce a distributed computer system to establish communication between one or more content partner computer systems and a custom document creation computer system, receive an indication of a customer's interest in creating a customized document, pass content data from one or more of the content partner computer systems to the custom document creation computer system according to the customer's indicated interest, induce the custom document creation computer system to integrate the content data and create a customized document, and induce the custom document creation computer system to create a durable record of the customized document.

### BRIEF DESCRIPTION OF THE DRAWINGS

FIG. 1 is a block diagram of one embodiment of a custom document creation system.

FIG. 2 illustrates a schematic process flow of systems and methods for creating custom documents.

FIG. 3 is a block diagram of further embodiments of a custom document creation system.

FIG. 4 is a block diagram of embodiments of a custom document creation system.

FIG. 5 illustrates embodiments of a process flow of data integration in a project management perspective of a custom document creation system.

FIG. 6 illustrates an embodiment of an exemplary custom document.

FIG. 7 illustrates an embodiment of a flow diagram indicating a customer's interaction with a custom document creation system.

### DETAILED DESCRIPTION OF THE PREFERRED EMBODIMENT

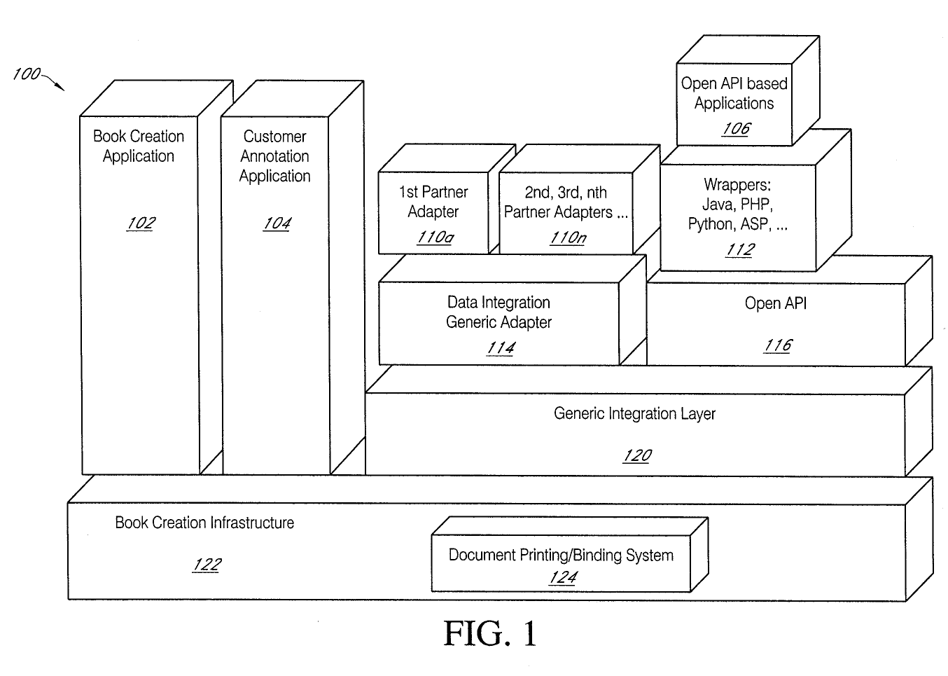

FIG. 1 illustrates embodiments of a custom document creation system 100. The system 100 supports data integration between one or more content partners and the system 100 to allow a user or customer to create an individually customized document. The documents can have a wide variety of themes including but not limited to yearbooks or annuals, remembrance books for deceased loved ones, travel mementos, travel guides, historical event documentaries, sports or other recreational interests, hobbies, service or “how to” guides, recipe books, family gatherings, and the like.

The system 100 can also print for the user a durable document, such as a book. The system 100 can also store a retrievable/readable durable record of the document, such as on computer readable storage media. Certain embodiments preferably include creation of durable printed documents, such as hardcover books, notebooks, magazines, newspapers and the like. Some embodiments can also include integrating customized data and storing such data on recordable media such as magnetic tape, optical storage media, magnetic storage media, flash memory, and the like. In certain embodiments, a customer can further indicate that they wish to have their custom document stored remotely and access the document as desired, for example, via a communication network.

In one embodiment, the system 100 comprises a book creation application 102 and a customer annotation application 104. The book creation application 102 operates to define and manage a data architecture to provide a template for creation of individually customized documents. The customer annotation application 104 supports receipt of commands and data from a customer to individually customize or annotate a document template according to their individual interests.

In one embodiment, the system 100 also comprises one or more open API-based applications 106. The open API-based applications 106 use a set of interfaces that allow a plurality of independent web-based resources or websites to interact and support requests for services among the member systems

In some embodiments, the system 100 includes one or more partner adaptor modules 110a through 110n. The partner adaptor modules 110 facilitate bidirectional communication between the system 100 and a corresponding content partner. The partner adaptor modules 110 facilitate bidirectional communication of data and commands to facilitate exchange of content and communicate requests for or messages with desired content. In some embodiments, the system 100 also comprises one or more wrappers 112, such as JAVA, PHP, Python, ASP, and the like, to facilitate manipulation and handling of data within the system 100. The system 100 supports data

In some embodiments, the system 100 also comprises a data integration generic adaptor 114. The data integration generic adaptor 114 is configured to facilitate integration of data exchanged among one or more partner adaptors 110 where the particular format or syntax of communication with different content partners may vary. The system 100 supports integration of data that can be static or dynamic in nature. For example, data can be relatively static, such as historical information or photos, but can also be dynamic in nature, such as the content of a blog site. The system 100 also supports integration of data where some of the data can be fixed and other data can be user selectable or personalizable. For example, in one embodiment a content partner can designate that certain data, such as branding/logo data, remain unmodified and appear in the final product. Other content partner content, such as a bank of photos and a collection of comments and/or articles can be user selectable. This embodiment allows a user to personalize a document by indicating the photos and text they wish to appear in their document and select out other content.

As previously noted, in at least some embodiments, the system 100 comprises an open API aspect as indicated by the module 116. The open API module 116 provides methods for definition of data within the system 100. For example, the open API module 116 can define a title, a source, a summary, a time, a date and/or an author of the data. In some embodiments, the open API module 116 proceeds in an automatic manner, for example, such that content is automatically pushed to the system 100 as it becomes available from a given content partner and need not require a manual or request message from the system 100 to induce delivery of the updated content.

The open API module 116 is also configured to accommodate a wide variety of development environments and/or sources. For example, in one embodiment the open API module 116 interfaces with RSS feeds. RSS can include but is not limited to one or more of the following formats: Really Simple Syndication (RSS 2.0), Rich Site Summary (RSS 0.91 and RSS 1.0) and RDF Site Summary (RSS 0.9 and RSS 1.0). RSS formats can be specified in XML and RSS can be configured to deliver or exchange information as XML files. The open API module 116 can also be configured to exchange content with one or more blogger sites and/or exchange of content via email.

In some embodiments, the system 100, including in one embodiment the data integration generic adapter 114 and open API 116, comprise representational state transfer (REST) architectures. In some embodiments, the REST-based system 100 defines a relatively simple interface that supports transmission of domain-specific data over hypertext transfer protocol (HTTP) without requiring additional messaging layers, such as SOAP or session tracking with HTTP cookies. In REST-based embodiments of this system 100, resources are uniquely addressable using a universal syntax for use in hypermedia links. In these embodiments, resources share a uniform interface for transfer of state between client and resource including a constrained set of operations and a constrained set of content types.

In some embodiments, the system 100 further comprises a generic integration layer 120. The generic integration layer 120 is adapted to integrate a wide variety of content data from different sources. In one embodiment, the generic integration layer 120 is configured to integrate data from the data integration generic adapter 114 and from the open API 116. In one embodiment, the generic integration layer 120 comprises a non-human interface.

In some embodiments, the system 100 also comprises a book creation infrastructure 122. The book creation infrastructure is adapted to interface with non-human components, such as the data integration generic adapter 114 and the open API 116 and with a human interface, such as the customer annotation application 104. As previously noted, in at least some embodiments, the system 100 is configured to generate a durable printed document for at least some customers. Thus, in some embodiments, the system 100 further comprises a document printing/binding system 124. The document printing/binding system 124 is adapted to print high quality black and white and/or color pages and to bind the printed pages for example in a hard cover or laminated soft cover format. In some embodiments, the document printing/binding system 124 can also be adapted to print and bind magazine-type format printed documents, tri-fold pamphlets, comb-bound and/or three-ring binder notebook type documents, and the like.

Also, as previously noted, and in at least some embodiments, the system 100 can be configured to integrate content and prepare a compiled or aggregated document but need not in all implementations create a printed document. For example, a user may prefer to have created for them a remembrance document but rather than having a printed book created may instead wish to have the aggregated content stored on a storage media such as a removable storage media and/or a storage media that can be accessed by a computer system with or without assistance of a communication network.

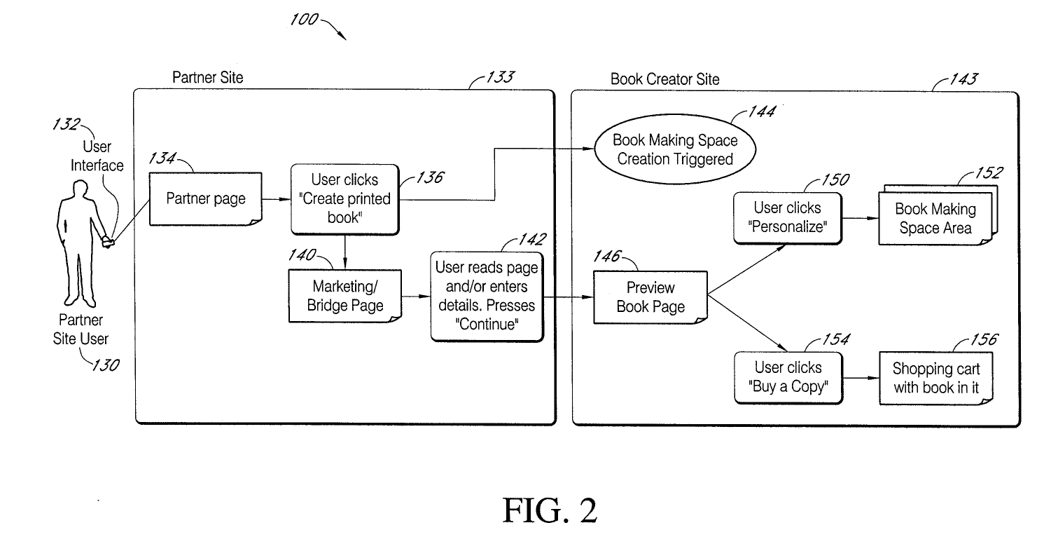

FIG. 2 illustrates a process flow of embodiments of a custom document creation system 100. The designator 130 indicates a user or customer of the system 100. The customer 130 can access the system for example, via a user interface 132. The user interface 132 can comprise a personal computer, a portable computing device, an expanded capability cellular telephony handset, or other electronic devices adapted for communication. The user interface 132 would generally include a display capability and ability to provide user input controls to allow the user 130 to indicate their requirements and interests. In some embodiments, the customer 130 would access the system 100 by communicating with a chosen partner site 133. For example, a customer 130 may interact with a selected content partner site 133 to create a remembrance document. However, the content partner site 133 need not itself create the remembrance document.

In one embodiment, a user 130 communicating with a content partner site 133 would view a partner page 134 which would indicate their interest in creating a remembrance document and provide an avenue for purchase of such a document and provision for individual customization of the document. For example, upon accessing the partner page 134, a user can be presented with a control module 136 allowing the user to indicate their interest in creating a printed book for example by clicking or moving a cursor into alignment with a control button on the partner page 134.

Indication of the customer interest represented by the designator 136 can launch a marketing/bridge page 140. The marketing/bridge page 140 can be presented to the user to allow the user to review and read the page, enter any additional details desired, and indicate their continued interest in creation and purchase of a remembrance document, for example, by pressing a “continue” user control. User expression of interest is indicated by the designator 142.

In at least some embodiments, upon indication of the user's interest in creating a remembrance document, a block 144 is implemented at a book creator site 143. As previously noted, the content partner site 133 is in at least some implementations adapted for creation and/or forwarding of content but may not be configured for actual creation of the remembrance document. Rather, the book creator site 143 can be configured for the aggregation or data integration of the content corresponding to the customer's desired remembrance document, including data integrated from the partner site 133 and possibly other third party sources with personal content provided by the user/customer. The book creator site 143 can be further configured for the creation of the remembrance document which, in at least some embodiments can include creation of a printed document. By initiating the document making space block 144 upon receipt of indication of the customer's interest 136, the system 100 can more rapidly prepare and present a remembrance document to the customer 130 thereby improving the speed of response of the system 100 and increasing customer 130 satisfaction. For example, in at least some implementations, the system 100 can begin creation of the document, e.g., begin data integration, before the customer 130 has fully specified the desired document.

In one embodiment, following the block 142, the book creator site 143 can generate and present a document preview page 146. In some embodiments, the customer 130 can be redirected from the partner site 133 to the book creator site 143 for viewing of the document preview page 146. In other embodiments, the book creator site 133 can return the document preview page 146 to the partner site 133 such that the customer 130 can view the document preview page 146 within the partner site 133.

Following from the document previous page 146 a user can elect to personalize their document as indicated by the designator 150. Upon indication of interest in personalizing their document, the user can be directed a book making space area 152 where they can modify their document. For example, the customer 130 can transmit one or more photographs to be added to their document. The customer 130 can submit text to be included in their document. The customer 130 can provide self-created data or can provide data obtained from a third source.

In some embodiments, the system 100 can be configured to support sharing and collaboration among multiple users. For example, the system 100 can be configured to invite other users to a book making space created on behalf of a first user and review the first user's aggregated data. By accessing an already created book making space, subsequent users experience a much faster book creation process. In some embodiments, the system 100 utilizes already transferred content and merges or aggregates only data that is new or updated. The other users can be presented the opportunity to purchase the customized document created on behalf of the first user. In some embodiments, other users can have the opportunity to further customize a custom document originally created for another user. Thus, in some embodiments, a plurality of users 130 can collaborate and share their own individual content to create customized books. A book making space created for a first user can be defined as closed to further customization by other users or can be open to further modification. The open or closed aspect of a bookmaking space can be defined by the user 130, the partner site 133, and/or the book making site 143.

When the customer 130 is satisfied with the document as indicated on the document preview page 146, the user 130 can elect to purchase the document as indicated by the designator 154. In one embodiment, the customer 130 is directed to a shopping cart page 156 with an indication of the document. The shopping cart page 156 can provide the option to purchase one or more copies of the document, the shopping cart page 156 can also provide price information for the document, any applicable taxes, shipping charges as appropriate, and the like.

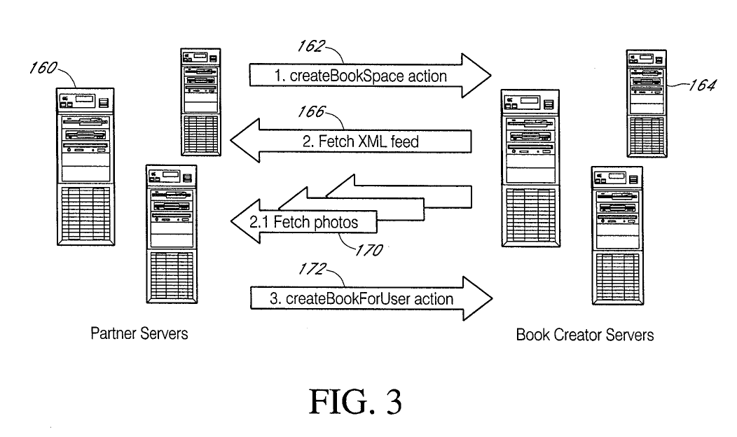

FIG. 3 illustrates schematically information and command flow between various components of a custom document creation system 100. In one embodiment, the system 100 includes one or more partner servers 160. The partner servers support and maintain corresponding partner sites 133 and generally store and communicate associated content. In some embodiments, at least some content from content partners is stored locally by the system 100. As previously noted, a customer 130 can access the system 100 by establishing communication with a partner site 133 that in some embodiments is associated with a corresponding partner server 160. This can establish a create book space action 162. The create book space action 162 communicates the customer's interest in a document to one or more book creator servers 164. The book creator servers 164 are configured to support and operate the book creator site 143.

Upon receipt of the create book space action 162, one or more of the book creator servers 164 can provide a fetch XML feed command 166. The fetch XML feed 166 communicates to the partner servers content or other data needed by the book creator servers 164 to proceed with creation of the document. For example, in one embodiment, the book creator servers can also pass a fetch photos command 170 to the partner servers 160 to indicate the need for one or more content photos maintained and held by corresponding partner servers 160.

In one embodiment, the partner servers 160 can subsequently issue a create book for user action 172 to be returned to the book creator servers 164. The create book for user action 172 is a confirmation of the customer's 130 continued interest in creation and purchase of a document and can further include a return transmission of content requested by the customer 130.

In some embodiments, content returned from the partner servers to the book creator servers can correspond directly to particular instructions of the customer 130. For example, the customer 130 may indicate specific photographs, articles, text, hypertext links, and the like that they wish to have included in their document. In some embodiments, the particular content forwarded from the partner services 160 to the book creator servers 164 can be inferred from the customer's 130 general indication of interest in the document. For example, a customer 130 may indicate their interest in creation and purchase of a travel remembrance document corresponding to their recent vacation in Italy.

However, the customer 130 need not necessarily indicate specific photographs or information that they wish included. Rather the system 100 can automatically aggregate photos, text, and the like corresponding to a vacation in Italy without any specific indication from the customer 130 of the exact data to be aggregated. Similarly, a customer 130 may indicate their interest in creation and purchase of a remembrance document for a deceased loved one. In some embodiments, the customer 130 can simply indicate the name of the deceased and the system 130 can be configured to automatically aggregate appropriate information, such as biographical information, friend and family data, achievements and awards, work history, family photos, information about their hobbies, and the like again without explicit customer 130 indication of specific content to be included in the document.

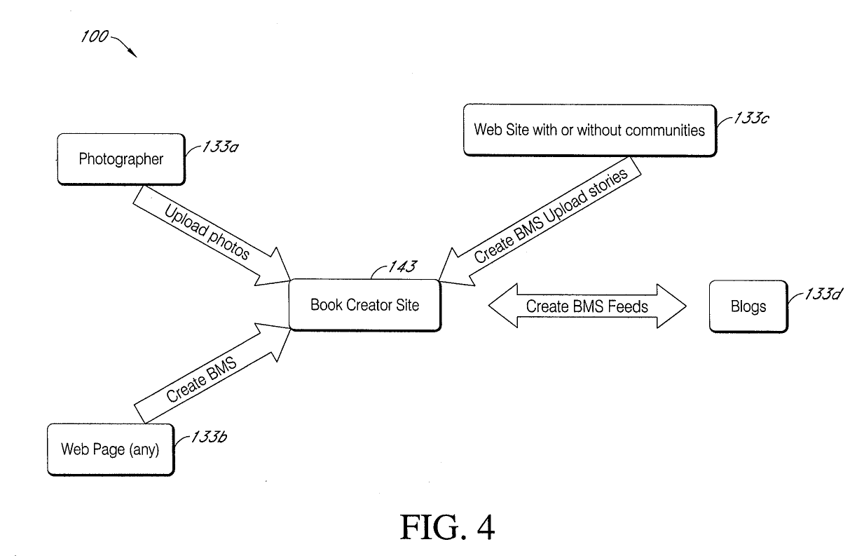

FIG. 4 illustrates additional embodiments of data integration between a document creation site 143 and a plurality of content partner sites 133. For example, in one embodiment, a photographer content partner 133a can upload photos to the document creator site 143. A generic webpage partner site 133b can allow a customer 130 to indicate their interest in the document and pass a create book-making site command to the document creation site 143. The webpage partner site 133b can comprise for example, a news site, an encyclopedia site, a sports site, a special interest site, or any other site that a customer 130 can visit and indicate their interest in a remembrance document.

133c indicates a website that can include or may not include user communities. For example, the website 133c can comprise an owner or fan website with a community of interested users that can include registered members and nonregistered guests. The websites 133 can similarly convey a create bookmaking site message to the document creation site 143. The websites 133c can further upload stories, articles, photos, calendar information, and the like for inclusion in documents created by the document creation site 143.

In yet further embodiments, one or more blog sites 133d can also pass a create bookmaking site command to the book creation site 143. In one embodiment, a book can be created from a blog. The one or more blogs 133d can also support one or more feeds, such as RSS feeds, to provide continuing content to the document creation site 143. Again, the content passed from the blogs 133d to the document creation site 143 can comprise text, photos, email, or any other of a wide variety of data formats.

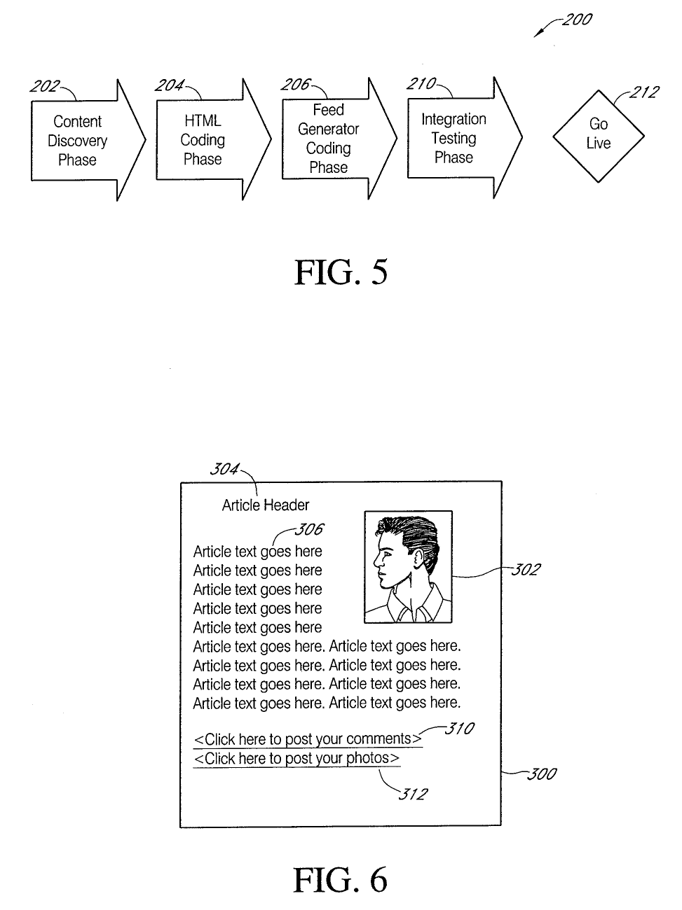

FIG. 5 illustrates a general project development process flow 200 for creating embodiments of a custom document creation system 100. Beginning in a phase 202, content of interest is searched and discovered. For example, the phase 202 can include identifying and establishing connection with partner content sites, independent creators of content, third party maintainers of content, and the like. Phase 202 can also include a decision process of what content the end product should have, for example photos, articles, format, headings, etc.

Once content of interest has been determined in phase 202, a phase 204 can be implemented to appropriately code the bridge page(s) 140. Phase 204 can include supporting collecting content from the user. Phase 204 can also include presenting customization/personalization options to the user.

Once the appropriate HTML coding has been completed in phase 204, a feed generation coding phase 206 can proceed. As previously noted, in at least some embodiments, the system 100 comprises an open API architecture and the feed generation coding phase 206 can correspond to appropriately calling the open API methods to allow communication between the various content sources and a document creation system.

Following the phase 206, an integration testing phase 210 can be implemented to evaluate and refine as needed the data integration among the various content sources and the document creation system. Once the integration testing phase has been successfully completed, the system 100 can go live in a block 212 where the system 100 is made available to customers 130.

FIG. 6 illustrates an example of a customized document 300 that can be created by a custom document creation system 100. In this embodiment, the document 300 comprises one or more photographs or graphic images 302 that can portray a portrait, scenery, a logo, and the like. The document 300 also comprises a header or title 304. In some embodiments, the header or title 304 can be uniquely associated with the document 300 to facilitate identification of a particular document 300 among a plurality of documents created and handled by the system 100. In this embodiment, the document 300 also includes prepared text 306. In general, the text 306 would be thematically associated with the document 300 and can be created by the custom document creation system 100 itself or can be obtained from one or more of the content partners.

In this embodiment, the document 300 also comprises a prompt field for the customer to provide their text or comments and is indicated by the designator 310. Similarly, the document 300 includes a prompt option for the customer 130 to provide additional photographs or other graphical images as indicated by the designator 312. In one embodiment, a user can select an existing photo and indicate another photo to replace the existing photo.

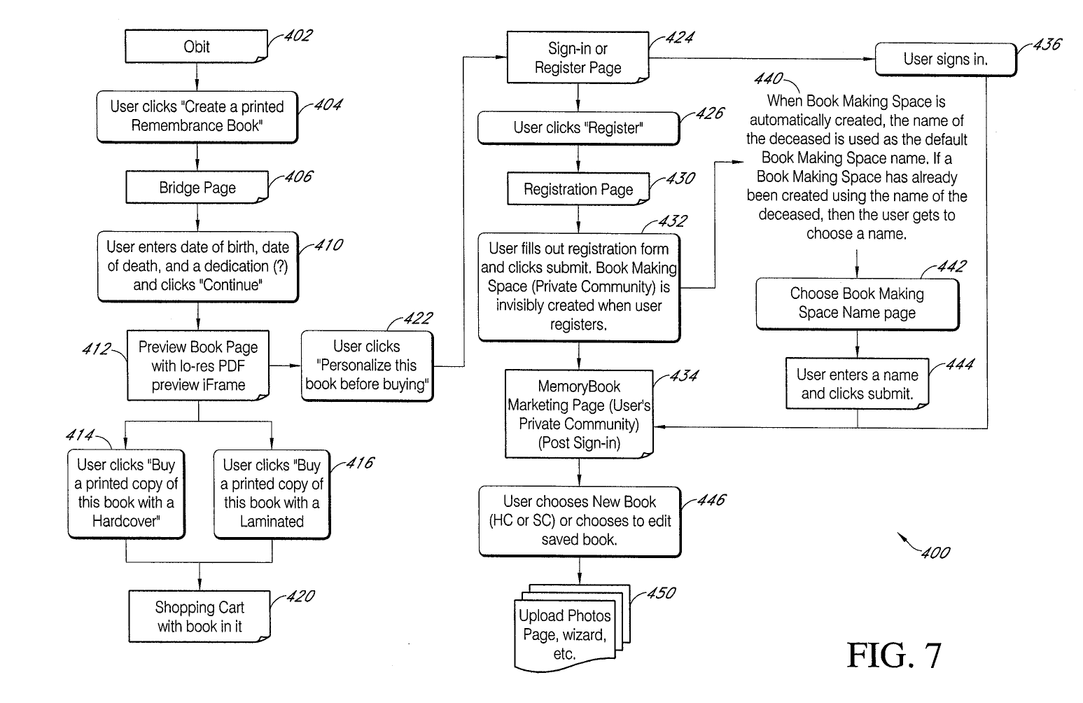

FIG. 7 is a flow chart of some embodiments of a system 100 and method 400 for creating custom or individualized documents. One embodiment will be described with respect to creating a remembrance or obituary document for a deceased loved one. However, it will be understood that the general process of the described embodiment can be readily applied to other themes or topics without detracting from the scope of the invention. Beginning at page 402, a user 130 can indicate their interest in creating and purchasing a customized document again, in this embodiment, illustrated with respect to an obituary remembrance. As indicated by the block 404, a user can confirm their interest in creating a customized document by selecting a control for example to “create a printed remembrance book.” A bridge page can then be implemented as indicated by block 406 to link a content partner with a document customization and creation system.

As indicated by a block 410, the customer and/or content provider can provide a variety of information to indicate the user's interests, for example by entering a date of birth, date of death, location, date of a memorial service, a dedication message, and the like. In some embodiments, the user would then indicate, for example by selecting a “continue” control, and induce the content partner to pass the data and parameters to the custom document creation system.

In some embodiments, the customer can be further presented with a preview page of their selected document. In some embodiments, this can include presentation of a lower resolution image file embedded within a display format such as a pdf. In some embodiments, the user is presented a more realistic representation of a book, such as via a Flash application where the user experiences a more realistic simulation of paging through a book, zooming to sections of interest, and the like.

If the user is satisfied with the preview of the document, a user can elect to purchase a hard cover copy of the printed document as a book in a block 414 or alternatively or in addition select a printed copy provided with a laminated soft cover binding in a block 416. In some embodiments, any of a wide variety of formats such as laminated hardcover, coil in case, e-books, or other binding formats are possible. Following in a block 420, a shopping cart would be presented with the book(s) in it, along with quantity and pricing information, expected delivery date, etc.

If, however, at block 412, the customer wishes to further personalize or customize their printed document, the customer can indicate this interest by selecting a further user control in a block 422, for example, by selecting a “personalize this book before buying” control. The customer would then be directed to a sign-in or register page as indicated by the block 424. If the customer has not yet registered with the custom document creation system 100, they can elect to register as indicated by a block 426. Selection of this control directs the customer to a registration page 430. As indicated in the block 432, the customer can provide registration information and submit this information to the system 100.

In one embodiment, a new bookmaking space is created when the user registers and in some embodiments the creation of the bookmaking space is transparent to the user. In one embodiment, the user is then directed to a book marketing page indicated by the block 434 comprising a private community for the user to grant them access to features and functions of the system 100. In some embodiments, from the registration page 430 and submission of registration information of block 432, a book or document making space is created, for example, using the name of the deceased as a default name for the document making space. If a document making space already exists using the name of the deceased, the user can be presented with the option to modify or vary the name to designate a unique customized and/or personalized document.

At a bookmaking space name page 442, the customer has the option of confirming a presented name or label for their custom document or can present or modify the name to create a unique identifier. Once the customer has selected a satisfactory name, the name is confirmed with the system 100, for example, by the customer selecting a “submit” control. The customer 130 would then be directed to the book marketing page 434.

From the book marketing page 434, the customer 130 can be presented with the option to have a new book created and can further have the option of printing format, for example, to print a hard cover or a soft cover book. In block 446, the customer 130 can also have the option of saving the customized document for later printing or for storage on recordable computer readable storage media. In a block 450, one or more photos or other graphical image files can be added to the custom document, for example, for cover art, a dedication photo an the like. Text annotations can also be added in addition to text already flowed into the book making space automatically from the partner site 133. For example, additional guest book entries can be added to a remembrance book.

In some embodiments, block 450 can also support selective deletion of pieces of content. In one embodiment, the partner site 133 can designate one or more pieces of content as user selectable, for example in the content acquisition phase 202. For example, a user could indicate that they do not wish certain guest book entries to appear in their final book. In some embodiments, the user site 133 can designate that certain content pieces are not selectable. For example, a partner site 133 can designate that branding content is not user selectable. Thus, in some embodiments, the partner site 133 maintains control of content that will always appear in a final product.

Thus, various embodiments provide a system that allows an interested customer 130 to indicate their desire in a remembrance document and also allow them to customize a document template according to their individual personal interests and desires. The customer 130 can access a system 100 either directly, for example, via a book creation site 143 or indirectly via a content provider site 133. Embodiments of the system 100 employ an open API format to facilitate data integration between the system 100 and a plurality of content partners. The open API aspect of certain embodiments facilitate ready access to the system 100 for the content partners and reduces the need for customized interface software development thereby also improving convenience and market access to the content partners.

The system 100 provides an additional avenue for the content partners to sell, license, and market their content product. Certain embodiments further allow content partners to pass branding or marketing tags with their content to further support marketing and brand awareness for the content partner. The system 100 can provide a variety of durable document formats, including hard cover printed books, soft cover printed books, magazines, pamphlets, newspapers, and the like as well as other recorded or stored formats, for example, on computer readable storage media. Some embodiments allow a customer to preview a customized document and to modify a document, for example, by adding customized text, personal comments, photos, other image files, hypertext links, and the like.

Although the above-disclosed embodiments of the present invention have shown, described, and pointed out the fundamental novel features of the invention as applied to the above-disclosed embodiments, it should be understood that various omissions, substitutions, and changes in the form of the detail of the devices, systems, and/or methods illustrated may be made by those skilled in the art without departing from the scope of the present invention. Consequently, the scope of the invention should not be limited to the foregoing description, but should be defined by the appended claims.

What is claimed is:

1. A system for creating customized documents, the system comprising:
a document creation system adapted to create customized documents;
a user interface adapted to allow a first user to input data and commands;
a communication network configured to communicate with one or more content partners and with the user interface to receive content data and to exchange requests; and
a document creation application, wherein the application is configured to allow the user to indicate interest in creating a first customized document and communicate that interest to the document creation system via the user interface and to induce the document creation system to obtain content data from the one or more content partners corresponding to the user's indicated interest and to create the first document customized according to the user's indicated interest.

2. The system of claim 1, wherein the document creation system obtains at least a portion of content to be placed in the customized document prior to receipt of the user's interest in the customized document.

3. The system of claim 1, wherein the document creation application is adapted to induce the document creation system to begin aggregating data to be placed in the customized document before the user has finished communicating their interests.

4. The system of claim 1, wherein the document creation application is adapted to induce the one or more content partners to periodically provide updated content data to the document creation system.

5. The system of claim 4, wherein the one or more content partners provide at least some content asynchronously with respect to indications of user interest.

6. The system of claim 1, wherein the document creation application is adapted to communicate a preview of the customized document for display on the user interface.

7. The system of claim 1, wherein the document creation application is adapted to utilize input provided via the user interface as at least a portion of the content of the customized document.

8. The system of claim 1, wherein communication between the one or more content partner servers and the document creation system comprises an open application programming interface.

9. The system of claim 1, further comprising one or more content partner servers adapted to provide a content partner site accessible by the user and wherein the user can access the system via the content partner site.

10. The system of claim 1, wherein the system is further adapted to present the first customized document created for the first user to at least a second user.

11. The system of claim 10, wherein the at least second user can create a second customized document as at least one of a revised version of the first customized document created for the first user and a new customized document.

12. The system of claim 1, further comprising a document printing/binding system adapted to print a copy of the customized document.

13. The system of claim 12, wherein the first user can designate a printing format of the customized document.

14. The system of claim 1, wherein at least a portion of content data in the customized document is not modifiable by the user.

15. The system of claim 1, wherein the first customized document comprises a document personalized according to the interests of an individual customer.

16. A method of creating a customized document, the method comprising:
receiving from a user an indication of interest in creating a customized document;
aggregating data from one or more content providers according to the user's indicated interests;
creating the customized document;
receiving an indication of desire to purchase the customized document; and
providing a durable record of the customized document.

17. The method of claim 16, further comprising obtaining at least some data from the one or more content providers prior to receipt of the indication of interest in creating a customized document and wherein the aggregating of data includes at least some of the previously obtained data.

18. The method of claim 16, further comprising displaying for the user a preview of the created customized document prior to providing the durable record.

19. The method of claim 16, further comprising receiving content from the user and wherein the aggregation of data includes aggregating at least some of the content received from the user.

20. The method of claim 16, wherein the providing the durable record of the created document comprises printing a book corresponding to the document.

21. The method of claim 16, further comprising receiving the data from the one or more content providers according to an open application programming interface.

22. The method of claim 16, comprising receiving indications of the user's interest in the document separately from indications of the user's desired customization of the document and wherein the aggregation of the data is at least initiated prior to complete receipt of the indications of the user's desired customization of the document.

23. The method of claim 16, further comprising:
sharing access to the customized document with multiple users to allow one or more of further customization of the customized document by the multiple users and providing durable records of the customized document to the multiple users.

24. The method of claim 16, wherein creating the customized document comprises personalizing the document according to the interests of an individual customer.

25. Computer readable storage media provided with instructions to induce a distributed computer system to:
establish communication between one or more content partner computer systems and a custom document creation computer system;
receive an indication of a customer's interest in creating a customized document;
pass content data from one or more of the content partner computer systems to the custom document creation computer system according to the customer's indicated interest;
induce the custom document creation computer system to integrate the content data and create a customized document; and
induce the custom document creation computer system to create a durable record of the customized document.

26. The computer readable storage media of claim 25, further comprising instructions to induce a user interface to receive and display a preview of the customized document prior to the creation of the durable record of the customized document by the custom document creation computer system.

27. The computer readable storage media of claim 25, further comprising instructions to induce the one or more content partner computer systems and the custom document creation computer system to establish communication according to an open application programming interface protocol.

28. The computer readable storage media of claim 25, further comprising instructions to induce the one or more content partner computer systems to periodically push at least one of text and image content data to the custom document creation computer system.

29. The computer readable storage media of claim 25, further comprising instructions to allow a plurality of users to access the customized document.

30. The computer readable storage media of claim 29, further comprising instructions to allow the plurality of users to perform one or more of further customize the customized document and purchase the durable record of the customized document.

31. The computer readable storage media of claim 25, further comprising instructions to induce the distributed computer system to personalize the document according to the interests of an individual customer.
